(19) United States
(12) Patent Application Publication
(10) Pub. No.: US 2010/0035124 A1
(43) Pub. Date: Feb. 11, 2010

(54) HYBRID PARTICLE AND CORE-SHELL ELECTRODE STRUCTURE

(75) Inventors: Eric L. Thompson, Livonia, NY (US); Anusorn Kongkanand, West Henrietta, NY (US); Frederick T. Wagner, Fairport, NY (US)

Correspondence Address: FRASER CLEMENS MARTIN & MILLER LLC, 28366 KENSINGTON LANE, PERRYSBURG, OH, 43551-4163, US

(73) Assignee: GM CLOBAL TECHNOLOGY OPERATIONS, INC., Detroit, MI (US)

(21) Appl. No.: 12/189,224

(22) Filed: Aug. 11, 2008

(51) Int. Cl. H01M 4/00; H01M 4/88; B05D 5/12

(52) U.S. Cl. 429/40; 502/101; 427/115

(57) ABSTRACT

A catalyst ink composition for a fuel cell electrode is provided. The catalyst ink composition includes: an ionomer; at least one solvent; a quantity of nanostructured thin film support cores; a catalyst formed from a precious metal, the catalyst coated onto the nanostructured thin film support cores; and a quantity of particles. The particles are configured to provide an electrode porosity that militates against excess water accumulation in the electrode formed from the ink composition upon a drying thereof. An electrode for a fuel cell and a method of fabricating the electrode with the catalyst ink composition are also provided.

### FIELD OF THE INVENTION

The present disclosure relates to electrodes for a fuel cell and, more particularly, to catalyst inks for fabrication of the electrodes for the fuel cell.

### BACKGROUND OF THE INVENTION

A fuel cell has been proposed as a clean, efficient and environmentally responsible power source for electric vehicles and various other applications. Individual fuel cells can be stacked together in series to form a fuel cell stack. The fuel cell stack is capable of supplying a quantity of electricity sufficient to power a vehicle. In particular, the fuel cell stack has been identified as a potential alternative for the traditional internal-combustion engine used in modern automobiles.

One type of fuel cell is the polymer electrolyte membrane (PEM) fuel cell. The PEM fuel cell includes three basic components: a pair of electrodes, including a cathode and an anode; and an electrolyte membrane. The electrolyte membrane is sandwiched between the electrodes to form a membrane-electrode-assembly (MEA). The MEA is typically disposed between porous diffusion media, such as carbon fiber paper, which facilitates a delivery of reactants such as hydrogen to the anode and oxygen to the cathode. In the electrochemical fuel cell reaction, the hydrogen is catalytically oxidized in the anode to generate free protons and electrons. The protons pass through the electrolyte to the cathode. The electrons from the anode cannot pass through the electrolyte membrane, and are instead directed to the cathode through an electrical load, such as an electric motor. The protons react with the oxygen and the electrons in the cathode to generate water.

The electrodes of the fuel cell are generally formed from a finely divided catalyst. The catalyst may be any electro-catalyst which catalytically supports at least one of an oxidation of hydrogen and a reduction of oxygen for the fuel cell electrochemical reaction. The catalyst typically is a precious metal, such as platinum or another platinum-group metal. The catalyst is disposed on a carbon support such as carbon black particles, and is typically dispersed in a proton-conducting polymer, also known as an ionomer. A typical ionomer is a perfluorosulfonic acid (PFSA) polymer. One type of perfluorosulfonic acid (PFSA) polymer is commercially available as Nafion® from the E. I. du Pont de Nemours and Company. The electrolyte membrane is likewise formed from an ionomer, typically in the form of a layer.

One known method of forming the electrodes of the fuel cell includes applying a catalyst ink to a suitable fuel cell substrate. An example of a catalyst ink and methods of application is described in U.S. Pat. No. 6,156,449 to Zuber et al., the disclosure of which is hereby incorporated herein by reference in its entirety. The catalyst ink typically contains the catalyst on the carbon support, the ionomer, and a solvent. The catalyst ink is subsequently dried to drive off the solvent and form the electrode having a thickness of about 10 microns to about 30 microns. Typical substrates include the electrolyte membrane, such as in a catalyst coated membrane (CCM) design, and the diffusion media such as in a catalyst coated diffusion media (CCDM) design.

The carbon support of electrodes from known catalyst inks is generally susceptible to electrochemical carbon corrosion. The presence of oxygen and high cell voltages due to local fuel starvation effects that occur during transient water blockage, shut-downs, and start-ups of the fuel cell stack can cause the corrosion of the carbon support particles. Carbon corrosion may significantly degrade the fuel cell performance over time, for example, by causing the catalyst to become disconnected electrochemically from the ionomer in the electrode and limiting the ability of the electrode to contribute to the fuel cell current.

Another known method of forming the electrodes of the fuel cell includes a core-shell material, for example, nanostructured thin film (NSTF) catalyst. The use of the NSTF catalyst is described by Debe et al. in “Nanostructured Thin Film Catalysts for PEM Fuel Cells by Vacuum Web Coating”, in proceedings of the 50^{th} Annual Technical Conference of the Society of Vacuum Coaters, Louisville Ky. (May 1, 2007), the entire disclosure of which is hereby incorporated herein by reference. The NSTF catalyst is typically formed by a physical vapor deposition (PVD) of thin catalyst films over a nanostructured thin film monolayer of oriented crystalline whiskers formed from an organic pigment material. One suitable organic pigment material is a perylene dicarboximide derivative designated as PR149 (CAS number). The NSTF whiskers are generally synthesized on a decal substrate and the whiskers are then transferred as-grown to the electrolyte membrane by direct lamination. For example, the as-grown whiskers may be embedded into the surface of the electrolyte membrane by hot roll pressing. The resulting NSTF electrode has a thickness of about 0.25 microns to about 0.5 microns.

The NSTF electrode is highly resistant to electrochemical corrosion. However, the NSTF electrode is susceptible to flooding from the water generated at the electrode, due to the relatively low porosity and thickness of the NSTF electrode in comparison to conventional electrodes from catalyst inks. At fuel cell operating temperatures below about 60° C., the flooding of the NSTF electrode is known to be particularly problematic. Additionally, the transfer of the NSTF whiskers to the electrolyte membrane from the decal substrate may be undesirable, resulting in blockage of mass transport due to the as-grown structure of the NSTF whiskers.

There is a continuing need for a catalyst ink composition for a fuel cell that provides an electrode that is durable, inexpensive, and resistant to carbon corrosion. Desirably, the catalyst ink composition provides an electrode that is optimized for water management and facilitates fuel cell start-up operations at low ambient temperatures.

### SUMMARY OF THE INVENTION

In concordance with the instant disclosure, a catalyst ink composition providing an electrode that is durable, inexpensive, resistant to carbon corrosion, optimized for water management, and facilitates fuel cell start-up operations at low ambient temperatures, is surprisingly discovered.

In a first embodiment, a catalyst ink composition for a fuel cell electrode includes an ionomer; at least one solvent; a quantity of nanostructured thin film support cores; a catalyst formed from a precious metal, the catalyst coated onto the nanostructured thin film support cores; and a quantity of particles configured to provide an electrode porosity that militates against excess water accumulation in the electrode formed from the ink composition upon a drying thereof.

In another embodiment, an electrode for a fuel cell includes an ionomer matrix with a quantity of nanostructured thin film support cores. A catalyst formed from a precious metal is deposited onto the nanostructured thin film support cores. The electrode further includes a quantity of particles. The catalyst-coated cores and the particles are substantially evenly distributed through the ionomer matrix. The particles are configured to provide an electrode porosity that militates against excess water accumulation in the electrode.

In a further embodiment, a method for fabricating an electrode for a fuel cell, includes the steps of: providing a substrate for the electrode; providing a catalyst ink composition including an ionomer, at least one solvent, a quantity of nanostructured thin film support cores, a catalyst formed from a precious metal, the catalyst coated onto the nanostructured thin film support cores, a quantity of particles configured to provide an electrode porosity that militates against excess water accumulation in the electrode formed from the ink composition upon a drying thereof; depositing the catalyst ink onto the substrate; and drying the catalyst ink to form the electrode for the fuel cell.

### DRAWINGS

The above, as well as other advantages of the present disclosure, will become readily apparent to those skilled in the art from the following detailed description, particularly when considered in the light of the drawings described herein.

FIG. 1 is a schematic cross-sectional view of a fuel cell having electrodes formed from the catalyst composition of the present disclosure;

FIG. 2 is an enlarged schematic view of one of the electrodes of the fuel cell depicted in FIG. 1, showing an ionomer matrix with a quantity of particles and a quantity of catalyst coated nanostructured thin film whisker cores distributed therein;

FIGS. 3A-3D show micrographs illustrating the distribution of whiskers in electrodes fabricated according to the present disclosure in comparison to electrodes fabricated from a transfer of as-grown whiskers to an electrolyte membrane; and

FIGS. 4A-4B show charts illustrating polarization curves at different temperatures of a membrane electrode assembly prepared according to the present disclosure, relative to a state-of-the-art membrane electrode assembly formed from as-grown NSTF whiskers.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, are not necessary or critical.

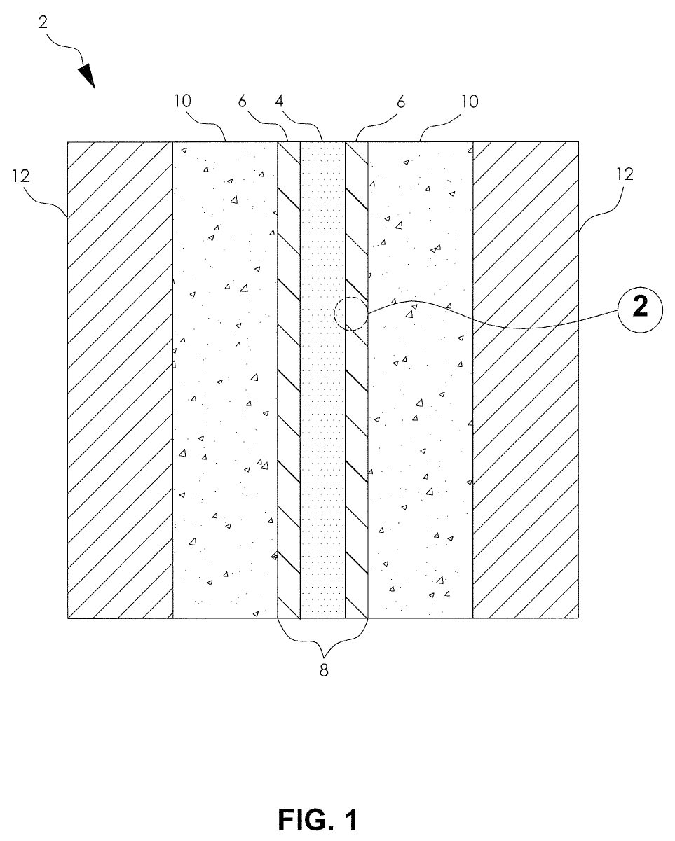

As shown in FIG. 1, an illustrative fuel cell 2 includes an electrolyte membrane 4 disposed between a pair of electrodes 6. The electrodes 6 form a cathode and an anode of the fuel cell 2 for use in the fuel cell electrochemical reaction as described hereinabove. It should be understood that the individual cathode and anode electrodes may have a different composition or structure, as desired. The electrodes 6 may be deposited onto the electrolyte membrane 4, such as in a CCM design, for example, to form a membrane electrode assembly (MEA) 8. Each of the electrodes 6 may have a gas diffusion layer 10 disposed adjacent thereto. The electrodes 6 may be deposited onto the gas diffusion layers 10, such as in a CCDM design, for example. The electrolyte membrane 4, the electrodes 6, and the gas diffusion layers 10 are typically further disposed between a pair of fuel cell plates 12. The fuel cell plates 12 may be unipolar or bipolar plates, for example, as are known in the art. In one embodiment, the fuel cell plates 12 are substantially as described in Assignee's co-pending U.S. application Ser. No. 11/696,361, hereby incorporated herein by reference in its entirety. Other electrolyte membrane 4, gas diffusion layer 10, and fuel cell plate 12 designs and configurations may be employed with the electrodes 6 of the present disclosure, as desired.

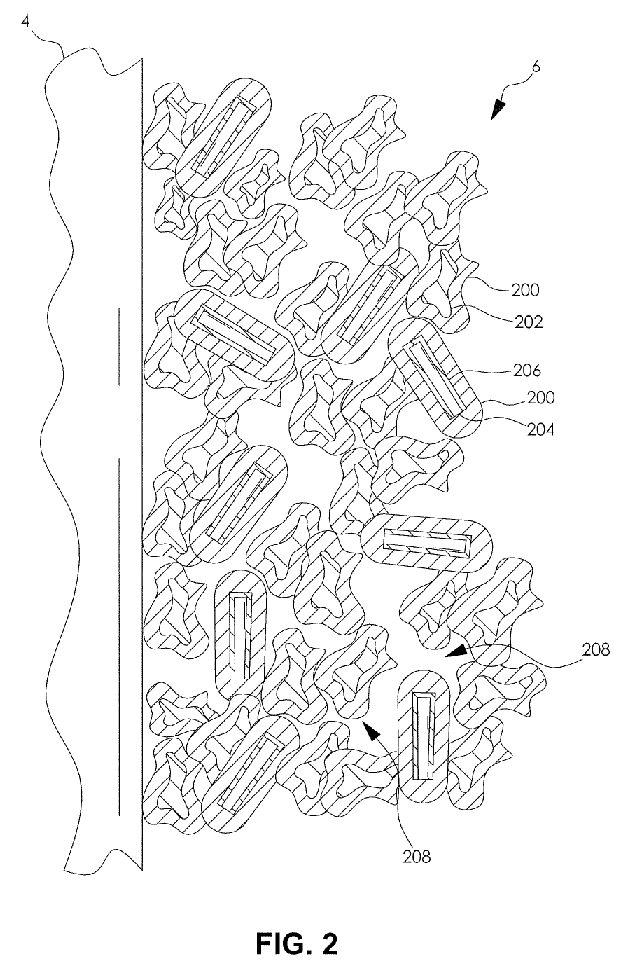

One embodiment of the electrode 6 of the present disclosure is shown in FIG. 2. The electrode 6 includes a matrix of an ionomer 200 having a quantity of particles 202 and a quantity of nanostructured thin film cores 204 randomly and substantially evenly distributed therethrough. At least one of the quantity of particles 202 and the quantity of nanostructured thin film cores 204 are electrochemically connected throughout the electrode 6. The cores 204 are coated with a catalyst 206 to form a core-shell catalyst structure. The quantities of particles 202 and cores 204 are further coated by the ionomer 200 to form the ionomer 200 matrix.

The ionomer 200 may include any suitable proton-conducting polymer that is substantially stable under the operating conditions and temperatures associated with operation of the fuel cell 2. In particular embodiments, the ionomer 200 is a polymer having sulfonic acid groups, for example, a perfluorosulfonic acid (PFSA) polymer, such as Nafion® from the E. I. du Pont de Nemours and Company. Other ionomer materials, including hydrocarbon ionomers such as sulfonated polyetherketones, aryl ketones, and polybenizimidazoles may also be used. One of ordinary skill in the art may select other proton-conducting polymers, as desired.

In certain embodiments, the quantity of particles 202 may be formed from any material having sufficiently high electrical conductivity and surface area for use in the fuel cell 2. The particles 202 are formed from a material that is sufficiently stable under fuel cell 2 operating conditions and does not generate an undesirable amount of cations which could contaminate the electrolyte membrane 4 and reduce proton conductivity. As nonlimiting examples, the particles 202 may be formed from a carbonaceous material, such as at least one of carbon black, graphite, and activated carbon. In another example, the particles 202 are formed from gold or an alloy thereof. In a particularly illustrative example, the particles are formed from carbon black particles coated with gold or an alloy thereof. Other electrically conductive materials may also be employed, as desired.

In other embodiments, the particles 202 may be formed form a substantially electrically nonconductive material. It should be understood that the quantity of the electrically nonconductive particles 202 in the electrode may be sufficiently low, however, in order to allow the catalyst coated cores to remain electrochemically connected throughout the electrode 6. The electrically nonconductive particle may be formed from one of zirconia, alumina, silica, and other substantially electrically insulating metal- and nonmetal-oxides, for example, that are sufficiently stable under fuel cell 2 operating conditions. Other suitable nonconductive materials may include ceramic materials such as metal or non-metal carbides, borides, nitrides, and silicides. The electrically nonconductive particles 202 may further be coated, for example, with electrically conductive materials, such as gold and alloys thereof. A skilled artisan may select suitable electrically nonconductive materials and electrically conductive coatings, as desired.

The particles 202 are configured to provide the electrode 6 with voids or pores 208 and thereby increase the surface area of the electrode 6. The pores 208 militate against excess water accumulation in the electrode 6 during operation of the fuel cell 2. The particles 202 may be agglomerated, for example, as a cluster or a mass of usually varied elements to provide the pores 208. The average size of the particles 202 may also be selected to provide the desired level of void porosity within the electrode 6. As a nonlimiting example, the particle size may range from about 20 nanometers to about 350 nanometers. Other particle sizes may be selected to provide the desired void porosity of the electrode 6.

The quantity of nanostructured thin film cores 204 is formed on a growing substrate such as a decal or a polymeric film, for example, as disclosed in U.S. Pub. App. Nos. 2007/0059452, 2007/0059573, 2008/0020261, and 2008/0020923 to Debe et al., the entire disclosures of which are hereby incorporated herein by reference. For example, the nanostructured thin film cores 204 can have a variety of geometries and orientations, including straight and curved shapes, and can be twisted, curved, hollow or straight, as desired. In a particularly illustrative embodiment, the nanostructured thin film cores 204 are longitudinally extended nanostructured thin film whiskers, although it should be appreciated that other shapes of nanostructured thin cores 204 may also be employed, as desired.

In certain embodiments, the nanostructured thin film cores 204 are formed using an organic pigment. The organic pigment may include a material having delocalized π-electrons, for example. In some implementations, the nanostructured thin film cores are formed from C.I. PIGMENT RED 149, also known as perylene red. The organic material used to form the nanostructured thin film cores 204 is capable of forming a continuous layer when deposited onto the growing substrate. In certain applications, the thickness of the continuous layer is in the range from about 1 nanometer to about one thousand nanometers.

In one embodiment wherein the cores 204 are longitudinally extended NSTF whiskers, the nanostructured thin film cores 204 formed from the organic pigment may have a length greater than about 1.5 microns, and an average thickness that ranges from about 0.03 microns to about 0.06 microns. In particular, the nanostructured thin film cores 204 may have an aspect ratio of length to diameter from about 3:1 to about 200:1. In one particular example, the nanostructured thin film cores 204 may have an aspect ratio of about 40:1. A skilled artisan may select cores 204 with suitable aspect ratios as desired.

One or more layers of the catalyst 206 coat the nanostructured thin film cores 204 and serve as a functional layer imparting desired catalytic properties to the nanostructured thin film cores 204. The catalyst 206 may further impart electrical conductivity and desired mechanical properties, e.g., strengthening and/or protecting the core of the catalyst coated nanostructured thin film cores 204. The catalyst 206 is formed from a precious metal having a catalytic activity suitable for use in the electrode 6 of the fuel cell 2. For example, the catalyst 206 may be formed from platinum or from one of the platinum group metals including palladium, iridium, rhodium, ruthenium, and alloys thereof. Suitable alloys based on platinum and another metal such as ruthenium, for example, may be employed. The catalyst 206 may include other alloying additions such as cobalt, chromium, tungsten, molybdenum, vanadium, iron, copper, and nickel, for example.

The catalyst 206 has a coating thickness on the nanostructured thin film cores 204 in the range from about 0.2 nanometers to about 50 nanometers, for example. In particular embodiments, the catalyst 206 is coated on the nanostructured thin film cores 204 in an amount ranging from about eighty (80) weight percent catalyst/core to about ninety-eight (98) weight percent catalyst/core. Other suitable thicknesses and weight percent ratios of the catalyst 206 to the nanostructured thin film cores 204 may be selected, as desired.

The catalyst 206 coating may be deposited onto the as-grown nanostructured thin film cores 204 on the growing substrate using conventional techniques, including, for example, those disclosed in U.S. Pat. Nos. 4,812,352 and 5,039,561, the entire disclosures of which are hereby incorporated herein by reference. Any method that avoids disturbance of the nanostructured thin film cores 204 by mechanical forces can be used to deposit the catalyst 206 coating. Suitable methods include, for example, vapor phase deposition (such as vacuum evaporation, sputter coating, and chemical vapor deposition), solution coating or dispersion coating (such as dip coating), spray coating, spin coating, pour coating (such as pouring a liquid over a surface and allowing the liquid to flow over the nanostructured thin film cores 204, followed by solvent removal), immersion coating (such as immersing the nanostructured thin film cores 204 in a solution for a time sufficient to allow the nanostructured thin film cores 204 to adsorb molecules from the solution, or colloidals or other particles from a dispersion), electroplating and electroless plating.

In an illustrative embodiment, the catalyst 206 coating may be deposited by vapor phase deposition methods, such as, for example, ion sputter deposition, cathodic arc deposition, vapor condensation, vacuum sublimation, physical vapor deposition, chemical vapor deposition, ion assisted deposition or jet vapor deposition™, for example. In particular, the catalyst 206 is deposited by physical vapor deposition onto the nanostructured thin film cores 204 prior to their inclusion in the catalyst ink composition of the present disclosure. Other means and methods for depositing the catalyst 206 onto the nanostructured thin film cores 204 may be employed.

It should be appreciated that the particles 202 in the electrode 6 do not support the catalyst 206. In a particular embodiment, the catalyst 206 is disposed substantially exclusively on the nanostructured thin film cores 204, as opposed to the ionomer 200 and the particles 202 of the electrode 6. In particular, the catalyst 206 may substantially coat the nanostructured thin film cores 204. The coating may be substantially even or gradated along the surface of each nanostructured thin film core 204, for example. In another embodiment, the catalyst 206 is deposited onto the nanostructured thin film cores 204 as discrete precious metal particles. For example, the catalyst 206 may be deposited on the nanostructured thin film cores 204 at nucleation sites on the nanostructured thin film cores 204 which grow into the discrete precious metal particles. In a further embodiment, a portion of the catalyst 206 may also be disposed on the particles 202, for example, as a coating on the particles or as discrete precious metal particles as described above.

The electrodes 6 of the present disclosure are fabricated from a catalyst ink composition. The catalyst ink composition includes the ionomer 200, at least one solvent, the quantity of longitudinally extended nanostructured thin film support cores 204, and the catalyst 206 formed from a precious metal, wherein the catalyst 206 is coated onto the nanostructured thin film support cores 204. The catalyst ink composition further includes the quantity of particles 202 configured to provide the electrode with the desired porosity.

The solvent typically includes at least one of an organic solvent and an aqueous solvent. Suitable solvents for solvating the ionomer 200 may include water, mono- and polyhydric-alcohols, glycols, and glycol ether alcohols, and glycol ethers. The ionomer 200 may be provided pre-solvated, for example, as part of an aqueous solution containing water and an alcohol. A particularly useful solvent for the catalyst 206 is ethanol, for example, which may be employed to optimize the dispersion thereof in the catalyst ink One of ordinary skill in the art should also understand that less polar solvents, for example, a longer chain alcohol such as propanol, isopropanol, butanol, pentanol, and hexanol, may also be particularly advantageous in providing a desirable level of dispersion of the nanostructured thin film support cores 204 in the catalyst ink composition.

One of ordinary skill in the art may select the particular relative amounts of the ionomer 200, the quantity of longitudinally extended nanostructured thin film support cores 204, the catalyst 206 formed from the precious metal, and the at least one solvent, as desired, for example, to provide the desired void porosity, and thickness of the electrode 6. The weight ratio of the ionomer 200 to the nanostructured thin film support cores 204 in the catalyst ink composition is typically between about 25:1 and about 1:10, and in particular about 1.1:1. The weight ratio of the ionomer 200 to the particles 206 is typically between about 15:1 and about 1:10, and in particular about 1:1.2.

To produce a desirably homogeneous catalyst ink dispersion, the abovementioned ingredients may be admixed and ball milled with a milling media, such as ceramic beads having sufficiently high density as known in the art. Suitable ceramic beads may include yttria-stabilized zirconia beads, for example. The beads may have an average diameter from about 3 mm to about 5 mm, for example. The catalyst ink may be mixed for up to about 72 hours, for example, or until the particles 202 and the nanostructured thin film support cores 204 are sufficiently dispersed within the catalyst ink composition. Other known auxiliaries may also be used such as, for example, high-speed stirrers, ultrasound baths, or three-roll mills.

The present disclosure further includes a method of fabricating the electrode 6 using the catalyst ink composition. The method first includes the steps of providing a substrate for the electrode 6 and providing a catalyst ink composition including the ionomer 200, the at least one solvent, the quantity of nanostructured thin film support cores 204 with the catalyst 206 coated thereon, and the quantity of particles 202. The substrate is generally at least one of the electrolyte membrane 4 and the gas diffusion layer 10. Other suitable substrates may be selected as desired.

The catalyst ink is then deposited onto the substrate. The step of depositing the catalyst ink onto the substrate may include at least one of spraying, dipping, brushing, roller transfer, slot die coating, gravure coating, Meyer rod coating, and printing the catalyst ink onto the substrate. The step of depositing the catalyst ink onto the substrate may also include a decal transfer process of laminating a polymeric substrate, such as one of PTFE, ePTFE, and ETFE, to the electrolyte membrane 4. The catalyst ink composition is deposited at a thickness sufficient for the electrode 6, following a drying of the catalyst ink, to have a thickness optimized for catalyst 206 loading and electrocatalytic activities. The thickness of the electrode 6 produced following the drying of the catalyst ink composition is between about 1 microns and about 10 microns, and in particular about 3 microns. It should be appreciated that the employment of the particles 202 and the nanostructured thin film support cores 204 facilitates the employment of a thinner electrode 6 than provided with conventional catalyst ink compositions while militating against flooding of the electrode 6 during operation of the fuel cell 2.

Following the deposition of the catalyst ink onto the substrate, the catalyst ink is dried to form the electrode 6. The drying of the catalyst ink to form the electrode 6 is generally conducted at an elevated temperature selected to drive off the at least one solvent without thermally degrading the ionomer 200, the particles 202, the nanostructured thin film support cores 204, and the catalyst 206. In a particular embodiment, the step of drying the catalyst ink includes drying the catalyst ink with an infrared drier. Other means of the drying the catalyst ink may also be employed. As a nonlimiting example, the catalyst ink may be dried at a temperature of about 300° F. for up to about 4 minutes. Other suitable drying temperatures and times may also be employed. It should be appreciated that with the catalyst ink composition of the present disclosure, however, the drying time may be optimized due to the ability to form the electrode 6 with an optimized thickness through use of both the particles 202 and the nanostructured thin film support cores 204.

The method of the present disclosure may further include providing a growing substrate having the quantity of catalyst coated cores 204 disposed thereon. The growing substrate may be a corrugated decal, for example, having the as-grown cores 204. Decals having the catalyst coated cores 204 in the shape of whiskers have been manufactured, for example, by 3M Innovative Properties Company in St. Paul Minn. The catalyst coated cores 204 are then collected from the growing substrate for inclusion in the catalyst ink composition. For example, the catalyst coated cores 204 may be collected from the growing substrate by mechanically scraping the catalyst coated cores 204 from the growing substrate, such as by pulling the growing substrate over a conveyer roller to break up the core 204 backplane and disclosed the catalyst coated nanostructured thin film cores 204 from the growing substrate. The catalyst coated cores 204 may also be collected from the growing substrate by sonication, such as by application of ultrasonic sound energy to the growing substrate having the catalyst coated cores 204. Other suitable means for separating the catalyst coated cores 204 from the growing substrate without substantially degrading the core-shell structure may also be employed.

In another example, the catalyst coated cores 204 may be collected from the growing substrate by dissolving the growing substrate in a suitable solvent, and removing the resulting solution to recover the catalyst coated cores 204. Alternatively, the catalyst coated cores 204 may be collected from the growing substrate by transferring the catalyst coated cores 204 from the growing substrate to a dissolvable polymeric membrane, such as a water soluble polyethylene oxide membrane, for example. Other readily dissolvable materials may also be employed. The polymeric membrane is then dissolved in the solvent. The resulting solution is removed to recover the catalyst coated cores 204 for the catalyst ink composition. The solution may be removed by filtration or the like. In other embodiment, the solution may be stirred to cause the catalyst coated cores 204 to precipitate from the solution. The supernatant solution may subsequently be decanted so that the catalyst coated cores 204 may be harvested.

It should be appreciated that the dissolving of the one of the growing substrate and a polymeric membrane having the catalyst coated cores 204 disposed thereon further provides a well-defined and well-controlled core 204 geometry, as opposed to the somewhat random geometry that may occur if the core backplane is transferred to the electrolyte membrane 4, for example, by direction lamination. It should be further appreciated that the catalyst coated cores 204 may be transferred to the dissolvable polymeric membrane under temperature and pressure conditions that facilitate a controlled removal of the catalyst coated cores 204 from the backplane. For example, the transfer pressure is desirably minimized to militate against a transfer of the backplane with the catalyst coated cores 204. It is surprisingly found that transferring whisker-shaped catalyst coated cores 204 to a PFSA membrane at a temperature of about 300° F. and a pressure of about 1300 psi (about 10,000 lbs total force over about a 50 cm² area) results in a separation and a removal of the backplane with the growing substrate, leaving only the catalyst coated cores 204 with a consistent geometry on the PFSA membrane. The pressure may be applied over a period of about 4 minutes, for example. One of ordinary skill in the art may select other suitable temperature and pressure conditions to separate the backplane from the catalyst coated cores 204, as desired. The more consistent nanostructured thin film core 204 geometry may contribute to an optimized fuel cell 2 performance and durability.

The catalyst coated cores 204 can also be separated from the growing substrate with solvent without dissolving the growing substrate. The growing substrate may be rinsed with a suitable solvent, often an organic solvent such as heptane and the like, to dislodge the catalyst coated cores 204 from the growing substrate without dissolving the substrate or the catalyst coated cores 204. The solvent may be applied to the growing substrate with a pressure sufficient to dislodge the catalyst coated cores 204, for example. Suitable solvents may be selected as desired.

### EXAMPLES

The following examples are merely illustrative and do not in any way limit the scope of the disclosure as described and claimed.

A first catalyst ink formulation according to the present disclosure was prepared by mixing the ingredients shown in Table 1 below. The ingredients were added simultaneously and ball milled with a ceramic milling media for about 72 hours.

TABLE 1

| CATALYST INK COMPOSITION | WT % |
|---|---|
| Catalyst coated NSTF Whiskers (Pt) | 1.9% |
| Particles (Carbon Black) | 1.4% |
| Ionomer | 1.7% |
| Water | 38.0% |
| Ethanol | 38.0% |
| Isopropanol | 19.0% |
| TOTAL | 100.0% |

*5% solids solution

A control MEA and an example MEA were prepared. The control MEA included an electrode formed by direct lamination of as-grown catalyst coated whiskers from 3M Innovative Properties Company in St. Paul Minn. to an electrolyte membrane. The example MEA included an electrode prepared according to the present disclosure with the five percent (5%) solids catalyst ink composition shown in Table 1. The example MEA was prepared by depositing and drying the catalyst ink composition substantially as described hereinabove. In both MEAs, the electrolyte membranes were about 25 μm Nafion® NRE211.

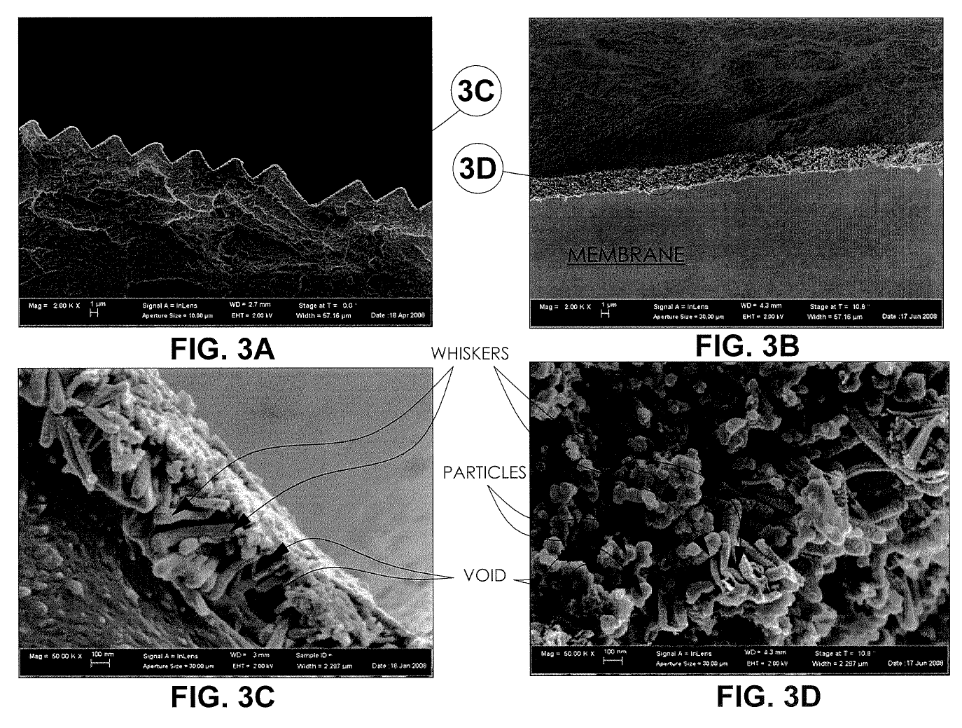

As shown in FIGS. 3A-3D, the surface of the first example MEA was analyzed by scanning electron microscope (SEM) to scales of about 1 micron and about 100 nanometers. A greater void porosity was observed with the example MEA shown in FIGS. 3B and 3D in comparison to the control MEA shown in FIGS. 3A and 3C. A sufficiently even distribution of the particles 202 and the catalyst coated whisker-shaped cores 204 was also observed in the electrode formed according to the present disclosure.

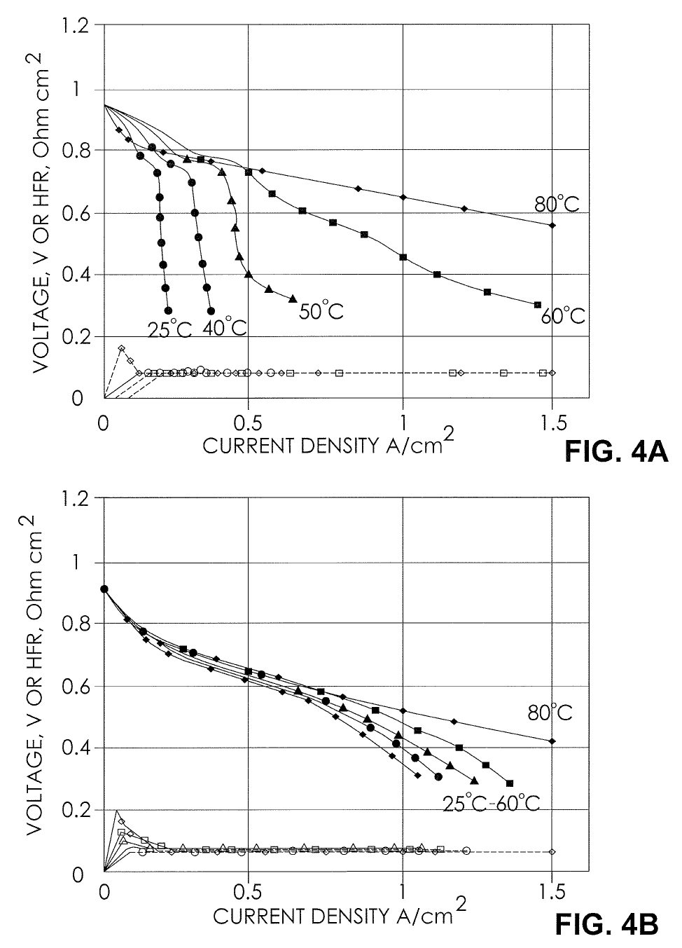

The voltage of the control and example MEAs were tested over a variety of temperatures and current densities typical of fuel cell operating conditions. As shown in FIG. 4A, the control MEA having the as-grown catalyst coated whiskers embedded in the electrolyte membrane exhibited a significant drop in voltage with a decrease in temperature. As shown in FIG. 4B, the example MEA prepared according the present disclosure did not exhibit a significant drop in voltage with the decrease in temperature.

It is surprisingly found that fuel cells 2 having the electrodes 6 prepared according to the present disclosure contribute to optimized water management of the fuel cells 2, thereby facilitating start-up operations of the fuel cells 2, particularly at low ambient temperatures. In particular, the electrodes 6 militate against the flooding known to occur with conventional electrodes having as-grown nanostructured whiskers. The resulting electrodes 6 are also durable and may be inexpensively produced using known catalyst ink techniques.

Carbon corrosion and catalyst dissolution normally associated with use of catalyst coated carbon particles is also militated against with the electrode 6 of the present disclosure. The total amount of catalyst and the requisite thickness of the electrode 6 may also be optimized through use of both the particles 202 and the catalyst coated cores 204 in the hybrid electrode 6.

While certain representative embodiments and details have been shown for purposes of illustrating the invention, it will be apparent to those skilled in the art that various changes may be made without departing from the scope of the disclosure, which is further described in the following appended claims.

What is claimed is:

1. A catalyst ink composition for a fuel cell electrode, comprising:
an ionomer;
at least one solvent;
a quantity of nanostructured thin film support cores;
a catalyst formed from a precious metal, the catalyst coated onto the nanostructured thin film support cores; and
a quantity of particles configured to provide an electrode porosity that militates against excess water accumulation in the electrode formed from the ink composition upon a drying thereof.

2. The catalyst ink composition of claim 1, wherein the particles are electrically conductive.

3. The catalyst ink composition of claim 2, wherein the particles are formed from one of gold and an alloy thereof.

4. The catalyst ink composition of claim 2, wherein the particles are formed from one of carbon black, graphite, and activated carbon.

5. The catalyst ink composition of claim 2, wherein the particles are formed from carbon black particles coated with one of gold and an alloy thereof.

6. The catalyst ink composition of claim 1, wherein the particles are electrically nonconductive and present in the composition in a quantity that allows the catalyst coated cores to remain electrochemically connected upon the drying thereof.

7. The catalyst ink composition of claim 1, wherein the nanostructured thin film support cores are formed from an annealed perylene dicarboximide derivative.

8. The catalyst ink composition of claim 1, wherein the nanostructured thin film support cores have an aspect ratio of length to mean cross-sectional diameter from about 3:1 to about 200:1.

9. The catalyst ink composition of claim 1, wherein the ratio of the particles to the nanostructure thin film support cores is from about 20:1 to about 1:5.

10. The catalyst ink composition of claim 1, wherein the catalyst is coated onto the nanostructured thin film support cores by vapor phase deposition.

11. An electrode for a fuel cell, comprising:
an ionomer matrix with a quantity of longitudinally extended nanostructured thin film support cores, a catalyst formed from a precious metal deposited onto the nanostructured thin film support cores, and a quantity of particles substantially evenly distributed through the ionomer matrix, the particles configured to provide an electrode porosity that militates against excess water accumulation in the electrode.

12. The electrode of claim 11, wherein the electrode has a thickness of about 1 micron to about 10 microns.

13. The electrode of claim 12, wherein the electrode has a thickness of about 3 microns.

14. A method for fabricating an electrode for a fuel cell, comprising the steps of:
providing a substrate for the electrode;
providing a catalyst ink composition including an ionomer, at least one solvent, a quantity of nanostructured thin film support cores, a catalyst formed from a precious metal, the catalyst coated onto the nanostructured thin film support cores, a quantity of particles configured to provide an electrode porosity that militates against excess water accumulation in the electrode formed from the ink composition upon a drying thereof;
depositing the catalyst ink onto the substrate; and
drying the catalyst ink to form the electrode for the fuel cell.

15. The method of claim 14, wherein the step of providing the catalyst ink composition includes the steps of:
providing a growing substrate having the quantity of catalyst coated cores disposed thereon; and
collecting the catalyst coated cores from the growing substrate for inclusion in the catalyst ink composition.

16. The method of claim 15, wherein the catalyst coated cores are collected from the growing substrate by one of mechanically scraping and sonicating removal of the catalyst coated cores from the growing substrate.

17. The method of claim 15, wherein the catalyst coated cores are collected from the growing substrate by dissolving the growing substrate in a solvent, and removing the resulting solution to recover the catalyst coated cores.

18. The method of claim 15, wherein the catalyst coated cores are collected from the growing substrate by transferring the catalyst coated cores from the growing substrate to a dissolvable polymeric membrane, dissolving the polymeric membrane in a solvent, and removing the resulting solution to recover the catalyst coated cores.

19. The method of claim 14, wherein the step of depositing the catalyst ink onto the substrate includes at least one of spraying, dipping, brushing, roller transfer, slot die coating, gravure coating, Meyer rod coating, and printing.

20. The method of claim 14, wherein the step of drying the catalyst ink includes drying the catalyst ink with an infrared drier.
